(19) United States
(12) Patent Application Publication
(10) Pub. No.: US 2026/0184174 A1
(43) Pub. Date: Jul. 2, 2026

(54) VEHICLE MULTI-SCREEN CONTROL SYSTEM AND VEHICLE MULTI-SCREEN CONTROL METHOD

(71) Applicants: Hyundai Motor Company, Seoul (KR); Kia Corporation, Seoul (KR)

(72) Inventors: Yicheng FAN, Yantai (CN); Jun ZHOU, Yantai (CN); Yao YAO, Yantai (CN); Sungbo YANG, Hwaseong-Si (KR); Xiangyu CHEN, Yantai (CN)

(73) Assignees: Hyundai Motor Company, Seoul (KR); Kia Corporation, Seoul (KR)

(21) Appl. No.: 19/379,403

(22) Filed: Nov. 4, 2025

(30) Foreign Application Priority Data
Jan. 2, 2025 (CN) 202510006575.2

(51) Int. Cl. B60K 35/81; B60K 35/10; G06V 20/59; G06V 40/16; G06V 40/18; G06V 40/20

(52) U.S. Cl. CPC B60K 35/81; B60K 35/10; G06V 20/59; G06V 40/171; G06V 40/18; G06V 40/28; B60K 2360/1464; B60K 2360/149

(57) ABSTRACT

A vehicle multi-screen control system may include a plurality of displays disposed in the vehicle, a detector configured to detect an occupant and a gaze direction and a gesture of the occupant, and a controller configured to determine a display gazed at by the occupant from among the plurality of displays along the gaze direction of the occupant detected by the detector, determine a target operation according to the gesture of the occupant detected by the detector, and execute the target operation with respect to the display gazed at by the occupant, according to the display gazed at by the determined occupant and the determined target operation.

### CROSS-REFERENCE TO RELATED APPLICATION

The present application claims priority to and the benefit of Chinese Patent Application No. 202510006575.2 filed with the Chinese National Intellectual Property Administration on Jan. 2, 2025, the entire contents of which is incorporated herein by reference.

### BACKGROUND

### Technical Field

The present disclosure relates to a technical field of vehicle control, and more particularly, the present disclosure relates to a vehicle multi-screen control system and a vehicle multi-screen control method.

### Description of the Related Art

As technology advances, more displays, such as center console displays, passenger entertainment displays, and rear-seat displays, are being installed in vehicles to provide passengers with a variety of information.

In conventional technology, displays were mainly controlled through touch, but the present method had limitations. On the one hand, there is a certain safety risk as the driver's touching the display can momentarily distract the driver. On the other hand, the conventional scheme is convenient only when the passenger touches the display in front thereof, and it is very inconvenient if the passenger attempts to touch the display which is far away from them. For example, the passenger sitting in the back seat has to lean towards the front of the vehicle to touch the passenger entertainment display, and if the vehicle suddenly stops or shakes, the passenger's act of leaning out can also be a safety hazard.

That is, the conventional method of controlling the display by touch is difficult to meet the new demands for convenient, fast, and safe intelligent rooms.

The description of the above background technology is provided only for the convenience of deeply understanding the technical solution of the present disclosure (technical means used, technical problems to be solved, technical effects occurring, etc.), and should not be considered as an acknowledgment or in any form an implication that the information forms related art known to those skilled in the art.

### SUMMARY

The present disclosure attempts to provide a vehicle multi-screen control system and a vehicle multi-screen control method, in which, by determining a vehicle-mounted screen gazed at by the occupant by visually capturing a gaze direction of an occupant inside a vehicle, and controlling the vehicle-mounted screen gazed at by the occupant by visually capturing a gesture of the occupant, the occupant can switch between a plurality of vehicle-mounted screens through gazing different vehicle-mounted screens, implementing a more convenient and rapid control.

A vehicle multi-screen control system may include a plurality of displays disposed in the vehicle, a detector configured to detect an occupant and a gaze direction and a gesture of the occupant, and a controller configured to determine a display gazed at by the occupant from among the plurality of displays along the gaze direction of the occupant detected by the detector, determine a target operation according to the gesture of the occupant detected by the detector, and execute the target operation with respect to the display gazed at by the occupant, according to the display gazed at by the determined occupant and the determined target operation.

The controller may be configured to determine whether the occupant detected by the detector has a control authority with respect to the display gazed at by the occupant, after determining the display gazed at by the occupant and the target operation, and execute the target operation with respect to the display gazed at by the occupant, according to the display gazed at by the occupant and the target operation, when the controller concludes that the occupant detected by the detector has the control authority with respect to the display gazed at by the occupant.

The controller may be configured to determine whether the driver detected by the detector has a control authority with respect to the display gazed at by the driver, after determining the display gazed at by the driver and the target operation, when the occupant detected by the detector is a driver, and determine whether a current vehicle speed is smaller than a predetermined value, and execute the target operation with respect to the display gazed at by the driver, according to the display gazed at by the driver and the target operation, when the controller concludes that the driver has the control authority with respect to the display gazed at by the driver and the current vehicle speed is smaller than the predetermined value.

The controller may be configured to obtain a control authority relationship between a preset occupant and a display, in the determining of whether the occupant detected by the detector has the control authority with respect to the display gazed at by the occupant, and determine whether the occupant detected by the detector has the control authority with respect to the display gazed at by the occupant, according to the control authority relationship between the preset occupant and the display.

The target operation may include moving a pointer displayed on the display.

When the controller concludes that the display gazed at by the occupant along the gaze direction of the occupant detected by the detector is changed, in the executing the target operation of moving the pointer with respect to the display gazed at by the occupant, the controller may be configured to maintain the pointer at a last location to which the pointer has moved.

The detector may be configured to capture a facial image of the occupant, in the detecting of the gaze direction of the occupant, determine facial feature point coordinates including at least eye coordinates according to the facial image, and determine a head posture according to the facial feature point coordinates, and determine the gaze direction of the occupant according to an eye image among the eye coordinates, the head posture, and the facial image.

The controller may be configured to obtain a screen range of each in the plurality of displays, in the determining of the display gazed at by the occupant from among the plurality of displays along the gaze direction of the occupant detected by the detector, and determine a display from among the plurality of displays, whose screen range intersects the gaze direction of the occupant, and determine the determined display as the display gazed at by the occupant.

The detector may be configured to capture a hand image of the occupant, while detecting the gesture of the occupant, obtain core information of a hand from the hand image, where the core information may include a finger joint or a hand edge contour, and determine the gesture according to a state or state change of the core information of the hand.

The controller may be configured to obtain a mapping relationship between a preset gesture and the target operation, in the determining of the target operation according to the gesture of the occupant detected by the detector, and determine the target operation correspond to the gesture of the occupant detected by the detector, according to the mapping relationship between the preset gesture and the target operation.

A vehicle multi-screen control method may include detecting an occupant and a gaze direction and a gesture of the occupant, determining a display gazed at by the occupant from among a plurality of displays disposed in the vehicle according to the detected gaze direction of the occupant, determining a target operation according to the detected gesture of the occupant, and executing the target operation with respect to the display gazed at by the occupant, according to the display gazed at by the determined occupant and the determined target operation.

The vehicle multi-screen control method may further include determining whether the detected occupant has a control authority with respect to the display gazed at by the occupant, after determining the display gazed at by the occupant and the target operation, and executing the target operation with respect to the display gazed at by the occupant, according to the display gazed at by the occupant and the target operation, when the controller concludes that the detected occupant has the control authority with respect to the display gazed at by the occupant.

The vehicle multi-screen control method may further include determining whether the detected driver has a control authority with respect to the display gazed at by the driver after determining a display gazed at by the driver and the target operation, and determining whether a current vehicle speed is smaller than a predetermined value, when the detected occupant is a driver, and executing the target operation with respect to the display gazed at by the driver, according to the display gazed at by the driver and the target operation, when the controller concludes that the driver has the control authority with respect to the display gazed at by the occupant and the current vehicle speed is smaller than the predetermined value.

The determining of whether the detected occupant has the control authority with respect to the display gazed at by the occupant may include obtaining a control authority relationship between a preset occupant and a display, and determining whether the detected occupant has the control authority with respect to the display gazed at by the occupant, according to the control authority relationship between the preset occupant and the display.

The target operation may include moving a pointer displayed on the display.

The vehicle multi-screen control method may further include maintaining the pointer at a last location to which the pointer has moved, when the controller concludes that the display gazed at by the occupant along the detected gaze direction of the occupant is changed, in the executing the target operation of moving the pointer with respect to the display gazed at by the occupant.

The detecting of the gaze direction of the occupant may include capturing a facial image of the occupant, determining facial feature point coordinates including at least eye coordinates according to the facial image, and determining a head posture according to the facial feature point coordinates, and determining the gaze direction of the occupant according to an eye image among the eye coordinates, the head posture and the facial image.

The determining the display gazed at by the occupant from among the plurality of displays along the detected gaze direction of the occupant may include obtaining a screen range of each in the plurality of displays, and determining a display from among the plurality of displays, whose screen range intersects the gaze direction of the occupant, and determining the determined display as the display gazed at by the occupant.

The detecting the gesture of the occupant may include capturing a hand image of the occupant, obtaining core information of a hand from the hand image, where the core information may include a finger joint or a hand edge contour, and determining the gesture according to a state or state change of the core information of the hand.

The determining the target operation according to the detected gesture of the occupant may include obtaining a mapping relationship between a preset gesture and the target operation, and determining the target operation corresponding to the detected gesture of the occupant, according to the mapping relationship between the preset gesture and the target operation.

### BRIEF DESCRIPTION OF THE DRAWINGS

Hereinafter, an exemplary embodiment of the present disclosure will be described in detail with reference to the drawings. For clarity, the same members in different drawings are indicated with the same reference numerals. It should be noted that the drawings are illustrative only and are not necessarily drawn to scale.

FIG. 1 is a block diagram of a vehicle multi-screen control system according to an exemplary embodiment of the present disclosure.

FIG. 2 is a schematic diagram exemplarily showing a plurality of displays disposed in a vehicle.

FIG. 3A and FIG. 3B are schematic diagrams exemplarily showing actual usage effects of a vehicle multi-screen control system according to an exemplary embodiment of the present disclosure.

FIG. 4 is a schematic diagram showing an occupant switching between pointers of a plurality of displays.

FIG. 5 is a flowchart of a vehicle multi-screen control method according to an exemplary embodiment of the present disclosure.

### DETAILED DESCRIPTION

Hereinafter, embodiments of the present disclosure will be described in detail, and these embodiments are implemented based on the technical solution of the present disclosure, and detailed implementation methods and specific operation processes are disclosed, but the protection scope of the present disclosure is not limited to the following embodiments.

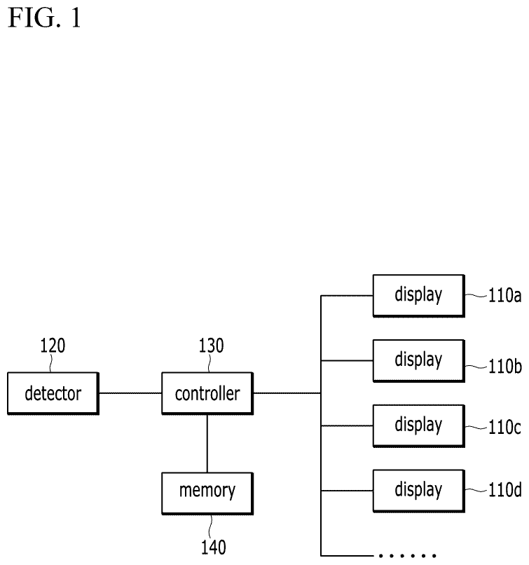

FIG. 1 is a block diagram of a vehicle multi-screen control system according to an exemplary embodiment of the present disclosure. As shown in FIG. 1, a vehicle multi-screen control system according to an exemplary embodiment of the present disclosure may include a plurality of displays (e.g., displays 110a, 110b, 110c and 110d), a detector 120, a controller 130 and a memory 140.

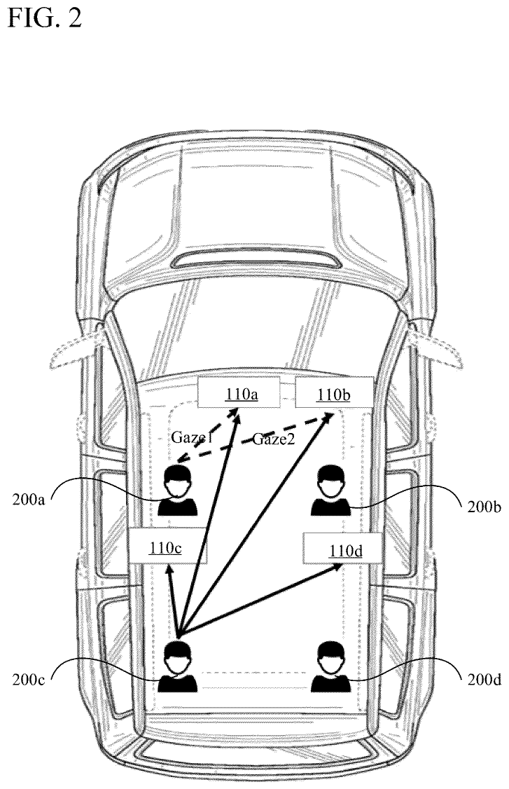

The display is an electronic device with a display function disposed in a vehicle. FIG. 2 exemplarily represents a schematic diagram of the plurality of displays disposed in the vehicle. As shown in FIG. 2, the displays 110a, 110b, 110c and 110d may be a center console display 110a, a passenger seat entertainment display 110b, a rear seat displays 110c and 110d, respectively, configured to display various information to occupants 200a, 200b, 200c and 200d. Types of the displays 110a, 110b, 110c and 110d are mere example, but the present disclosure is not limited to the location or number of the displays. For example, the center console display 110a may include at least one of an Audio, Video and Navigation (AVN) system display disposed in a center console of the vehicle, a cluster display, and a head-up display (HUD).

The detector 120 may be configured to detect an occupant (e.g., the occupant 200a) and detect a gaze direction and a gesture of the occupant (correspondingly, the occupant 200a). The detector 120 may be a camera disposed in the vehicle.

The detector 120 may capture a vehicle interior image, and may detect the occupant depending on the vehicle interior image and distinguish the occupants within the vehicle from each other. As shown in FIG. 2, the detector may detect occupants 200a, 200b, 200c, and 200d. As an example, the detector may distinguish the occupants 200a, 200b, 200c and 200d depending on seated locations of the occupants, and for example, the detector 120 may detect that the occupant 200a is a driver, the occupant 200b is an assistant driver, the occupant 200c is a rear left occupant, and the occupant 200d is a rear right occupant.

Furthermore, the detector 120 may capture a facial image and a hand image of the occupant, and may detect the gaze direction and the gesture of the occupant according to the facial image and the hand image of the occupant.

A gaze direction of the occupant may be understood as a light ray having a specific direction and a specific starting point.

Therefore, to detect the gaze direction of the occupant, the detector 120 may capture the facial image of the occupant, and then determine facial feature point coordinates according to the facial image. The facial feature points may mean feature points that can identify personal features located on the face, such as the eyes, nose, mouth, and eyebrows.

In more detail, the detector 120 may recognize the facial feature point from the facial image through a facial core point detection algorithm and display it, and may determine coordinates (i.e., the facial feature point coordinates) corresponding to each facial feature point based on the recognized facial feature point. When the determined facial feature point coordinates is 2-dimensional coordinates in the facial image plane coordinate system, calibration information of the detector 120 and reference location information of the occupant may be combined, and according to a computer vision 3-dimensional perspective proportional principle, the detector 120 may convert the facial feature point coordinates into 3-dimensional coordinates in a vehicle coordinate system.

The vehicle coordinate system may be a 3-dimensional Cartesian coordinate system that has the origin at a geometric center of the vehicle, and is formed by an X-axis direction of a vehicle's forward direction, a Y-axis direction of vehicle's left direction, and a Z-axis direction of vehicle's upward direction. The purpose of converting the facial feature point coordinates into 3-dimensional coordinates in the vehicle coordinate system is to standardize different measurement target data (i.e., a head posture, the gaze direction of the occupant, a screen range of the display mentioned below).

When the facial feature point coordinates is represented by 3-dimensional coordinates in the vehicle coordinate system, the detector 120 may determine the algorithm through the head posture, and may determine the head posture according to the facial feature point coordinates. The head posture means a 3-dimensional posture of the head in the vehicle coordinate system. After determining the head posture, the detector 120 may determine the gaze direction according to the eye image within the head posture and the facial image. The detector 120 may analyze elements in the eye image, such as pupil position of the eye, eyelid opening/closing angle, or the like, and may determine the gaze direction by combining the obtained head posture.

As described above, since the facial feature point includes eyes, the facial feature coordinates may include eye coordinates represented in 3-dimensional coordinates in the vehicle coordinate system. The detector 120 may take the eye coordinates as the specific starting point, and take the determined gaze direction as the specific direction, and may determine the gaze direction of the occupant according to the eye coordinates and gaze direction. The gaze direction of the occupant may be represented by a 3-dimensional vector whose size is not determined. As shown in FIG. 2, for example, the detector 120 may detect that the gaze direction of the occupant 200a is Gaze1.

To detect the gesture of the occupant, the detector 120 may capture the hand image of the occupant, and then obtain core information of the hand within the hand image. The core information may be a finger joint, and a hand edge contour. On the other hand, the detector 120 may determine a static gesture according to the state of the core information of the hand, and alternatively, the detector 120 may determine a dynamic gesture according to a state change of the core information of the hand. In other words, the detector 120 may extract the finger joint or the hand edge contour, and may detect a gesture by tracking the finger joint or the hand edge contour.

Referring back to FIG. 1, the controller 130 and the detector 120 may be electrically connected. On the other hand, the controller 130 may be configured to determine a display gazed at by the occupant from among a plurality of displays 110a, 110b, 110c and 110d, along the gaze direction of the occupant detect from the detector 120.

A screen of the display may be a plane (typically, a rectangle plane), and the screen range of the display may mean a range covered by the plane, and this may be represented as a group of 3-dimensional coordinates in the vehicle coordinate system, and for example, may include 3-dimensional coordinates in the vehicle coordinate system of each vertex of the plane. When each display in the plurality of displays 110a, 110b, 110c and 110d are all fixed in the vehicle, the screen range (i.e., a group of 3-dimensional coordinates in the vehicle coordinate system of the screen) of each display in the plurality of displays 110a, 110b, 110c and 110d may be stored in the memory 140, as a test calibration data of a test step of the vehicle. In the determining of the display gazed at by the occupant along the gaze direction of the occupant detect from the detector 120 by the controller 130, the controller 130 may obtain the screen range of each display in the plurality of displays 110a, 110b, 110c and 110d from the memory 140.

As described above, the gaze direction of the occupant may be represented as a light ray, and the screen range of the display may be represented as a plane, and when the occupant views a specific display, the gaze direction of the occupant may intersect a specific screen range of the display. Through this, the controller 130 may be configured to determine a display from among the plurality of displays, whose screen range intersects the gaze direction of the occupant, and may be configured to determine the determined display as the display gazed at by the occupant.

Taking an example of FIG. 2, when the gaze direction of the occupant 200a is Gaze1, if screen ranges of the gaze direction Gaze1 and the center console display 110a include an intersecting point, the center console display 110a may be the display gazed at by the occupant 200a. When the gaze direction of the occupant 200a is Gaze2, if screen ranges of the gaze direction Gaze2 and the passenger seat entertainment display 110b include an intersecting point, the passenger seat entertainment display 110b may be a target display gazed at by the occupant 200a.

Meanwhile, the controller 130 may be configured to determine a target operation according to the gesture of the occupant detected by the detector 120. To the present end, a gesture library may be preset, and the preset gesture library may be stored in the memory 140. Each gesture in the gesture library may be allowed as a gesture for manipulating the display, and each item of the gesture library may include a key-value pair that preserves mapping from the gesture to the target operation.

Table 1 the exemplarily represents one basic gesture library.

TABLE 1

| Item | | |
|---|---|---|
| number | Gesture | Target operation |
| Item 1 | Open hand and move it to the left | Move cursor to the left |
| Item 2 | Open hand and move it to the right | Move cursor to the right |
| Item 3 | Open hand and move it upward | Move cursor upward |
| Item 4 | Open hand and move it downward | Move cursor downward |
| Item 5 | Make a fist | Double-click cursor |
| Item 6 | Move index finger to the right | Fast forward of video |
| Item 7 | Move index finger to the left | Rewinding of video |

Conventionally, the user's manipulation with respect to a pointer (e.g., a cursor, a pointer, a tracking finger, a stylus, or the like) displayed on the display may be received by use of a pointing device such as a mouse, a light pen, a trackball or a pointing stick as a user input interface. It is well known that the mouse can control movement of the cursor on the display, and by use of a left button and/or a right button of the mouse, the cursor may be made to execute clicking, and moreover, a user interface control (including but not limited to an application (APP) icon, a button, a window, and a scroller) of the display may be manipulated.

In an exemplary embodiment of the present disclosure, by use of a gesture, the pointing device such as the mouse may be replaced. As shown in item 1 to item 4 of Table 1, the target operation may include moving the pointer displayed on the display. As shown in item 5 of Table 1, the target operation may involve causing the pointer to execute two consecutive clicks. A gesture of opening the hand and moving it to a specific direction may correspond to a target operation of moving the pointer in the same direction, and a gesture of making a first may correspond to a target operation of double-clicking of the pointer.

For example, in an example, when the occupant 200a tries to obtain navigation information from the center console display 110a, while gazing the center console display 110a, the occupant 200a may open the hand and move it so that the cursor displayed on the center console display 110a moves to a navigation APP icon, the occupant 200a may make a first so that the cursor double-clicks the navigation APP icon, and accordingly, the center console display 110a may pop-up a navigation window, to provide the navigation information to the occupant 200a. In another example, when the occupant 200b tries to trigger the function of a specific button (e.g., multimedia play button), while gazing the passenger seat entertainment display 110b, the occupant 200b may open the hand and move it so that the cursor displayed on the passenger seat entertainment display 110b moves to a corresponding button, and the occupant 200b may trigger the function of the button by making a first so that the cursor double-clicks.

In the Table 1, the target operation related to the pointer are mere example, the present disclosure does not limit the target operation related to the pointer. For example, the target operation may further include causing the pointer to execute clicking once, and by correlating the target operation with making a first and another gesture, in the manipulation with respect to the display, manipulation with respect to the user interface control of the pointer's clicking once and the pointer's double-clicking may be distinguished.

Unlike the information provided to the center console display 110a to assist the occupant 200a to drive the vehicle, the passenger seat entertainment display 110b and the rear seat displays 110c and 110d include a primary purpose to provide entertainment information to other occupants 200b, 200c and 200d of the vehicle. In such a case, the passenger seat entertainment display 110b and the rear seat displays 110c and 110d may be generally used for playing the video, and adjusting the playback progress of the video may be a general display manipulation. To adjust the playback progress of the video, the occupant can manipulate the cursor through gesture to double-click the “fast forward” button or the “rewind” button, but such manipulation method is very cumbersome.

Through this, as shown in item 6 and item 7 of Table 1, the target operation may further include adjusting the playback progress of the video displayed on the display screen. A gesture of moving an index finger to the right may correspond to the target operation of controlling fast forward of a video, and a gesture moving the index finger to the left may correspond to the target operation of adjusting rewinding of a video.

In other words, even if the target operation only includes a manipulation regarding the pointer, almost all interaction requests between the occupant and the display may be all satisfied, the target operation may still separately include a general display manipulation, and in the gesture library, such a general display manipulation may be associated with a corresponding gesture. Although adjusting the playback progress of the video is included in the target operation as a general display manipulation in Table 1, this is a mere example, and the present disclosure is not limited to the content of the target operation. For example, the target operation may include a navigation window pop-up, opening system setting, weather/calendar/text message/news/email notification, or the like.

Therefore, according to an exemplary embodiment of the present disclosure, the preset gesture library may be stored in the memory 140, the controller 130 may obtain a mapping relationship between a preset gesture and the target operation from the memory 140, and according to the mapping relationship between the preset gesture and the target operation, the controller 130 may be configured to determine the target operation corresponding to the gesture of the occupant detected by the detector 120.

Referring back to FIG. 1, since the controller 130 is electrically connected to the plurality of displays (e.g., the displays 110a, 110b, 110c and 110d), the controller 130 may execute the target operation with respect to the display gazed at by the occupant, according to the determined display gazed at by the occupant and the determined target operation.

Therefore, according to a vehicle multi-screen control system according to an exemplary embodiment of the present disclosure, by determining a vehicle-mounted screen gazed at by the occupant by visually capturing a gaze direction of an occupant inside a vehicle, and controlling the vehicle-mounted screen gazed at by the occupant by visually capturing a gesture of the occupant, the occupant can switch between a plurality of vehicle-mounted screens through gazing different vehicle-mounted screens, so that the occupant can control the plurality of vehicle-mounted screens inside the vehicle more conveniently and rapidly.

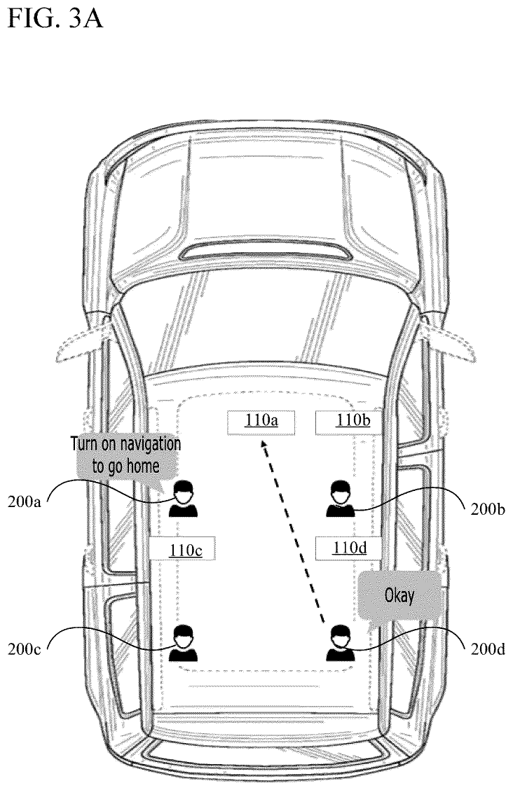

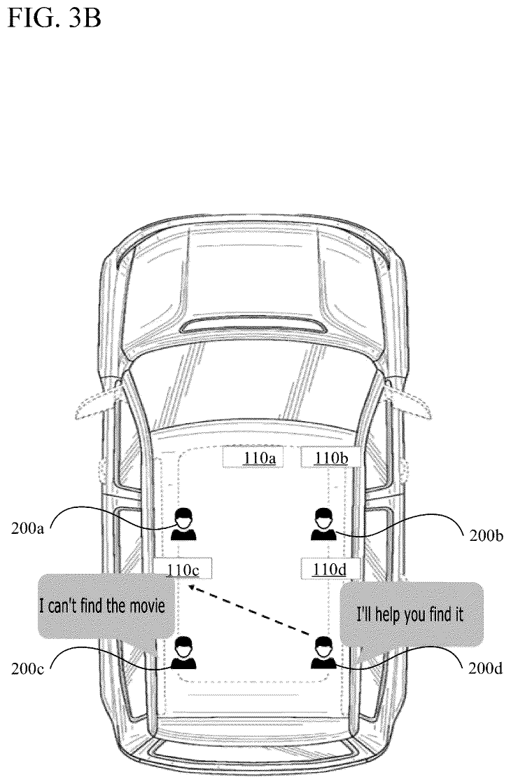

FIG. 3A and FIG. 3B are schematic diagrams exemplarily showing actual usage effects of a vehicle multi-screen control system according to an exemplary embodiment of the present disclosure.

As shown in FIG. 3A, while the occupant 200A drives the vehicle, when the occupant 200a is not familiar to the driving route and intends to obtain the navigation information from the center console display 110a, the occupant 200d may assist the occupant 200a to open the navigation window in the center console display 110, that is, the occupant 200d may gaze at the center console display 110a, and can open the navigation window in the center console display 110a through a gesture. Therefore, unlike the conventional art in which opening a navigation window by touching the center console display 110a by the driver may distract the driver to cause a safety risk, when a vehicle multi-screen system according to an exemplary embodiment of the present disclosure is used, the occupant 200d on the rear seat can help the occupant 200a to manipulate the center console display 110a, and the occupant 200a may concentrate in driving, ensuring safe driving of the vehicle.

As shown in FIG. 3B, the occupant 200c and the occupant 200d obtain the entertainment information (e.g., a movie, a radio, or a game) through the rear seat display 110c and the rear seat display 110d, respectively, the occupant 200c and the occupant 200d can manipulate the rear seat display in front of the other, that is, the occupant 200c may manipulate the rear seat display 110d, and the occupant 200d may manipulate the rear seat display 110c. For example, when the occupant 200c cannot find a movie, the occupant 200d may assist the occupant 200c to find a movie from the rear seat display 110c, that is, the occupant 200d may gaze at the rear seat display 110c, and may open the movie on the rear seat display 110c through a gesture. Therefore, unlike the conventional art in which the occupants needs to lean out to touch a display away from themselves, when a vehicle multi-screen control system according to an exemplary embodiment of the present disclosure is used, the occupant 200d can manipulate a display disposed away from him/her without moving the body, so that the manipulation becomes convenient and prompt while ensuring the personal safety of the occupant 200d.

However, allowing the occupant to manipulate multiple displays may also cause the safety problem. For example, when the occupant 200a obtains information helpful for driving the vehicle (e.g., the navigation information) through the center console display 110a, if a young occupant is allowed to manipulate the center console display 110a, it may cause an interference to the driving of the occupant 200a.

Therefore, in a preferable embodiment, after the controller 130 has determined the display gazed at by the occupant and the target operation, before the controller 130 executes the target operation with respect to the display gazed at by the occupant, the controller 130 may be configured to determine whether the occupant detected by the detector 120 has a control authority with respect to the display gazed at by the occupant.

For such a purpose, control authority relationship between the occupant and the display may be preset, and the preset control authority relationship between the occupant and the display may be stored in the memory 140.

In more detail, a vehicle user (e.g., a vehicle owner, a driver for the present trip, an occupant frequently boarded on the vehicle, or the like) may set a control authority relationship between the occupant and the display, through a user settings menu (USM) of an AVNT system.

As an example, a vehicle cabin room situation may be obtained by use of the vehicle interior image captured by the detector 120, and the vehicle cabin room situation may be displayed on the USM, through an AVNT system display, which is the center console display 110a. The vehicle cabin room situation may include at least the occupants within the vehicle and a seat location of each occupant, and for example, the AVNT system display may display the vehicle cabin room situation illustrated in FIG. 2.

Additionally, the USM may request the vehicle user to set a control authority relationship between the occupants 200a, 200b, 200c and 200d and the displays 110a, 110b, 110c and 110d. At the instant time, the vehicle user can set the control authority relationship between the occupants 200a, 200b, 200c and 200d and the displays 110a, 110b, 110c and 110d, by touching the AVNT system display or pressing a physical button of the AVNT system. Furthermore, whenever the vehicle cabin room situation (e.g., the occupant changes and/or seated location of the occupant changes) occurs, the AVNT system display displays the vehicle cabin room situation after the change on the USM, and therefore, the vehicle user can set again the control authority relationship between the occupant and the displays 110a, 110b, 110c and 110d after the change of the vehicle cabin room situation, in the USM.

Table 2 exemplarily represents the control authority relationship between the occupants 200a, 200b, 200c and 200d and the displays 110a, 110b, 110c and 110d.

TABLE 2

| | Display | Display | Display | Display |
|---|---|---|---|---|
| Control authority | 110a | 110b | 110c | 110d |
| Occupant 200a | √ | √ | × | × |
| Occupant 200b | √ | √ | × | × |
| Occupant 200c | √ | √ | √ | √ |
| Occupant 200d | √ | × | √ | √ |

According to an exemplary embodiment of the present disclosure, the controller 130 may obtain a control authority relationship between a preset occupant and a display from the memory 140, and the controller 130 may be configured to determine whether the occupant detected by the detector 120 has the control authority with respect to the display gazed at by the occupant according to the preset control authority relationship between the occupant and the display.

When the controller concludes that the occupant detected by the detector 120 has the control authority with respect to the display gazed at by the occupant, the controller 130 may execute the target operation with respect to the display gazed at by the occupant. For example, as represented in Table 2, the occupant 200d has a control authority of the center console display 110a and the rear seat display 110c. In the present situation, as shown in FIG. 3A and FIG. 3B, only then can the occupant 200d assist the occupant 200a to manipulate the center console display 110a or assist the occupant 200c to manipulate the rear seat display 110c.

In a situation that does not limit the number and location of the display, so that an exemplary embodiment of the present disclosure can reach the actual usage effects of FIG. 3A and FIG. 3B, the vehicle user can frequently assign the control authority of at least one front seat display to one of the occupants on the rear seats, and may assign the control authority of all the rear seat displays to one of the occupants on the rear seats.

To the contrary, when the controller concludes that the occupant detected by the detector 120 does not have a control authority for the display gazed at by the occupant, the controller 130 cannot execute the target operation with respect to the display gazed at by the occupant. For example, as represented in Table 2, the occupant 200d may not have a control authority of the passenger seat entertainment display 110b, which means, in other words, even if the occupant 200d gazes the passenger seat entertainment display 110b and attempts to manipulate the passenger seat entertainment display 110b by a gesture, the passenger seat entertainment display 110b will not respond.

Since the occupant 200a is the driver of the vehicle, a separate condition (e.g., a condition on the vehicle speed) needs to be necessarily set with respect to the occupant 200a, so that the vehicle driving safety at the time when the occupant 200a manipulates the display may be ensured.

Therefore, according to a preferable embodiment of the present disclosure, when the occupant detected by the detector 120 is the driver, after the controller 130 has determined a display gazed at by the driver and the target operation, before the controller 130 executes the target operation with respect to the display gazed at by the driver, the controller 130 may be configured to determine whether the driver detected by the detector 120 has a control authority with respect to the display gazed at by the driver, and may be configured to determine whether a current vehicle speed (which may be obtained from vehicle speed sensor) is smaller than a predetermined value (possibly, 20 km/), and when the controller concludes that the driver has a control authority for the display gazed at by the driver and that the current vehicle speed is smaller than the predetermined value, the controller 130 may execute the target operation with respect to the display gazed at by the driver.

As described above, in an exemplary embodiment of the present disclosure, the occupant of the present disclosure can manipulate the display through manipulating of the pointer, that is, each of the plurality of displays 110a, 110b, 110c and 110d may display the pointer enabling the occupant to manipulate. In the present situation, when the occupant alternately switches and manipulates the plurality of displays, if the pointers displayed on specific displays are randomly displayed whenever the occupant switches to the specific displays, the occupant needs to execute repeated manipulation with respect to the pointer, which may be cumbersome and inconvenient in the operation.

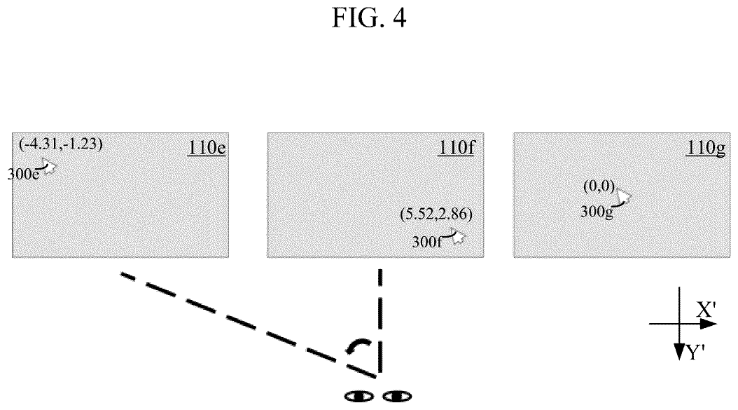

FIG. 4 represents a schematic diagram in which the occupant alternately switches and manipulates the pointers of the plurality of displays. As shown in FIG. 4, as described above, when the occupant intends to manipulate by alternately switching between a first display 110e, a second display 110f and a third display 110g, the occupant may only need to change the gaze direction and gaze the display to manipulate. Thereafter, the occupant can move the cursor displayed on the display to manipulate that is, change the location of the cursor, by opening the hand and move it.

The location of the cursor may be represented as 2-dimensional coordinates in a screen plane coordinate system. The screen plane coordinate system may have an origin at a center of the screen, and may be a 2-dimensional Cartesian coordinate system which is formed by taking a longitudinal direction of the screen as an X′ axis direction and a width direction of the screen as a Y′ axis direction.

The occupant can move a cursor 300f displayed on the second display 110f to a lower right end portion of screen of the second display 110f by gazing the second display 110f and opening the hand and moving it. At the instant time, a location of the cursor 300f may be represented as coordinates (5.52, 2.86).

Subsequently, the gaze of the occupant may depart from the second display 110f, to gaze at the first display 110e. In such a case, the coordinates (5.52, 2.86) may be a last location to which the cursor 300f has moved through the occupant operation, and the memory may store the coordinates (5.52, 2.86). Furthermore, the memory 140 may store the relationship between the second display 110f and the last location to which the cursor 300f has moved, by associating the coordinates (5.52, 2.86) with the display (the second display 110f) of the cursor 300f.

Table 3 exemplarily represents a relationship between a display stored in the memory 140 and the last location to which cursor has moved.

TABLE 3

| Display | Last location to which cursor moved |
|---|---|
| First display | (−4.31, −1.23) |
| Second display | (5.52, 2.86) |
| Third display | (0, 0) |

As represented in Table 3, the second display 110f and the last location (5.52, 2.86) to which the cursor 300f has moved may be related to each other. The controller 130 may obtain the last location to which the cursor related to the second display 110f 300f has moved, that is, the coordinates (5.52, 2.86) from the memory 140, and may maintain the cursor 300f at the coordinates (5.52, 2.86) of the screen of the second display 110f. When the occupant gazes the second display 110f again and wishes to manipulate the cursor 300f, the occupant can continue to manipulate the cursor 300f from the coordinates (5.52, 2.86), so that the manipulation may become more convenient.

In such a case, even if the second display 110f is turned off, the last location to which the cursor 300f has moved, the coordinates (5.52, 2.86) is stored in the memory 140, and therefore, when the second display 110f is turned on again, the controller 130 can obtain the last location to which the cursor related to the second display 110f 300f has moved from the memory 140, so that the cursor 300f is maintained at the coordinates (5.52, 2.86) of the screen of the second display 110f, to be standby for the manipulation.

Similarly, the occupant can move a cursor 300e displayed on the first display 110e to an upper left end portion of screen of the first display 110e by gazing the first display 110e and opening the hand and moving it, and at the instant time, a location of the cursor 300e may be represented as coordinates (−4.31, −1.23). Thereafter, the gaze of the occupant may depart from the first display 110e. In such a case, coordinates (−4.31, −1.23) may be the last location to which the cursor 300e has moved through the occupant operation, and memory may store coordinates (−4.31, −1.23) and the relationship between the first display 110e and coordinates (−4.31, 1.23), in Table 3. Correspondingly, the controller 130 may maintain the cursor 300e at coordinates (−4.31, −1.23) of the screen of the first display 110e.

In another situation, when the occupant has not yet manipulated a cursor 300g of the third display 110g, the cursor 300g may be located at a center of a screen of the third display, and that is, an initial location of the cursor 300g may be coordinates (0, 0), and at the instant time, the last location to which the cursor 300g has moved does not exist, so that the coordinates (0, 0) and the relationship between the third display 110g and the coordinates (0, 0) may be stored in Table 3.

As described above, according to an exemplary embodiment of the present disclosure, while the controller 130 is executing the target operation of moving the pointer with respect to the display gazed at by the occupant, when it is determined by the controller 130 that the display gazed at by the occupant has been changed along the gaze direction of the occupant detected by the detector 120, the controller 130 may maintain the pointer at the last location to which the pointer has moved.

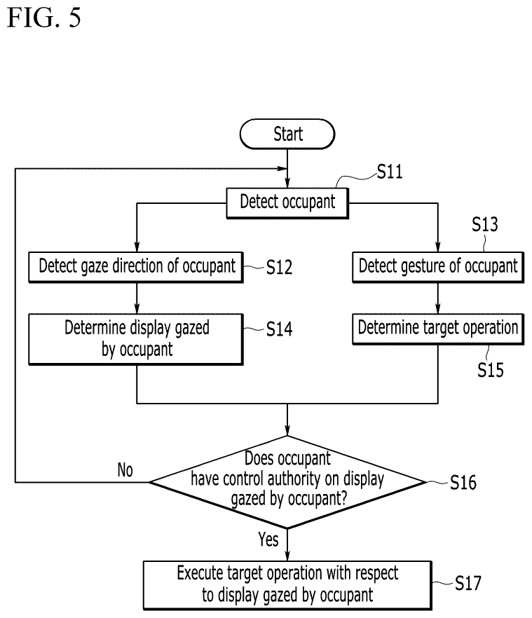

FIG. 5 is a flowchart of a vehicle multi-screen control method according to an exemplary embodiment of the present disclosure. As shown in FIG. 5, a vehicle multi-screen control method of an exemplary embodiment of the present disclosure may include, a step S11 of detecting the occupant (e.g., the occupant 200a), a step S12 of detecting the gaze direction of the occupant (correspondingly, the occupant 200a), and a step S13 of detecting the gesture of the occupant (correspondingly, an occupant 200a).

In more detail, the step S12 of detecting the gaze direction of the occupant may include, capturing the facial image of the occupant, determining the facial feature point coordinates including at least the eye coordinates according to the facial image, determining the head posture according to the facial feature point coordinates, and determining the gaze direction of the occupant according to the eye image among the eye coordinates, the head posture, and the facial image.

The step S13 of detecting the gesture of the occupant may include, capturing the hand image of the occupant; obtain the core information of a hand from the hand image, where the core information includes the finger joint or the hand edge contour, and determining the gesture according to a state or state change of the core information of the hand.

After the step S12 of detecting the gaze direction of the occupant, the display gazed at by the occupant may be determined from among the plurality of displays disposed in the vehicle according to the detected gaze direction of the occupant, at step S14.

In more detail, the step S14 of determining the display gazed at by the occupant from among the plurality of displays disposed in the vehicle according to the detected gaze direction of the occupant may include, obtaining a screen range of each in the plurality of displays; determine a display from among the plurality of displays, whose screen range intersects the gaze direction of the occupant, and determining the determined display as the display gazed at by the occupant.

After the step S13 of detecting the gesture of the occupant, the target operation may be determined according to the detected the gesture of the occupant, at step S15.

In more detail, the step S15 of determining the target operation according to the detected the gesture of the occupant may include, obtaining the mapping relationship between the preset gesture and the target operation, and determining the target operation corresponding to the detected the gesture of the occupant, according to the mapping relationship between the preset gesture and the target operation.

In a preferable embodiment of the present disclosure, the display gazed at by the occupant may be determined at the step S14, the target operation is determined at the step S15, and then whether the detected occupant has the control authority with respect to the display gazed at by the occupant is determined at step S16.

In more detail, the step S16 of determining whether the detected occupant has the control authority with respect to the display gazed at by the occupant may include, obtaining the control authority relationship between the preset occupant and the display, and determining whether the detected occupant has the control authority with respect to the display gazed at by the occupant, according to the control authority relationship between the preset occupant and the display.

When the controller concludes that the detected occupant has the control authority with respect to the display gazed at by the occupant (S16-Yes), the target operation may be executed with respect to the display gazed at by the occupant, according to the determined display gazed at by the occupant and the determined target operation, at step S17.

When the controller concludes that the detected occupant has the control authority with respect to the display gazed at by the occupant (S16-No), the target operation may not be executed with respect to the display gazed at by the occupant at the step S17, and the method may return to the step S11.

When the detected occupant is the driver, after determining the display gazed at by the driver and the target operation, as well as determining whether the detected driver has the control authority with respect to the display gazed at by the occupant, it is necessary to determine whether the current vehicle speed is smaller than the predetermined value; and when the controller concludes that the driver has the control authority with respect to the display gazed at by the driver and the current vehicle speed is smaller than the predetermined value, the target operation may be executed with respect to the display gazed at by the driver, according to the display gazed at by the driver and the determined target operation.

As an example, the target operation may include moving the pointer displayed on the display. While executing the target operation of moving the pointer with respect to the display gazed at by the occupant (e.g., the second display), when the controller concludes that the display gazed at by the occupant has been changed (e.g., changed to the first display) according to the detected gaze direction of the occupant, the pointer may be maintain at the last location to which the pointer has moved, so that the occupant can conveniently continue to manipulate the first display.

According to a vehicle multi-screen control system and a vehicle multi-screen control method of an exemplary embodiment of the present disclosure, when the vehicle is started, the system may automatically turn on the camera inside the vehicle, and the image captured by the camera may simultaneously proceed with the following two processes: one of which may be a gaze direction processing, in which 3-dimensional coordinates of the occupant's eye and a 3-dimensional vector of the gaze direction are obtain first, and accordingly, a group of 3-dimensional coordinates of vehicle-mounted screen ranges measured in advance are combined, to determine the display gazed at by the occupant; and the other one may be a gesture processing, in which the gesture of the occupant may be recognized, and the target operation may be determined based on the gesture library established in advance. After determining the display gazed at by the occupant and the target operation, whether the occupant has the control authority with respect to the display gazed by the occupant may be determined, and when the occupant does not have the control authority, the manipulation may be refused. The manipulation supported by the control authority may include moving the cursor displayed on the display, and after turning on the display, the cursor may be maintained at the last location at the time of the previous operation, to wait a cursor moving operation of the occupant.

When a vehicle multi-screen control system and a vehicle multi-screen control method according to an exemplary embodiment of the present disclosure is used, since the occupant can switch between the plurality of vehicle-mounted screens through gazing different vehicle-mounted screens, achieving more convenient and rapid control, and since the occupant controls the gazed vehicle-mounted screen through a gesture, there is no need to move the body by a significant amount, so that the safety risk while driving of the vehicle is reduced. Furthermore, the occupant seated on the rear seat can manipulate the front seat display and the rear seat display which is not located in front of himself, so that the usage of the vehicle-mounted screen is increased. Furthermore, the control method through the gaze direction and gesture can increase interactivity between the occupant and the vehicle-mounted screen, so that the occupant is allowed to perform more manipulations.

The various embodiments of the present disclosure are not intended to enumerate all possible combinations, but rather to illustrate representative aspects of the present disclosure, and furthermore, the contents described in the various embodiments may be applied independently or in combinations of two or more.

The description of the above embodiments is intended only to illustrate the technical solutions of the present disclosure and should not be considered complete, nor is it intended to limit the present disclosure to the precise form described. of course, it is self-evident that a person skilled in the field can make various modifications and changes according to the above-mentioned revelation. The selection and description of exemplary embodiments is intended to illuminate the specific principles of the present disclosure and its practical applications so that those skilled in the art can utilize each embodiment of the present disclosure and its different alternatives and modifications. The scope of the present disclosure is defined by the appended claims and their equivalents.

What is claimed is:

1. A vehicle multi-screen control system, comprising:
a plurality of displays disposed in the vehicle;
a detector configured to detect an occupant and a gaze direction and a gesture of the occupant; and
a controller operatively connected to the plurality of displays and the detector and configured to:
determine a display gazed at by the occupant from among the plurality of displays along the gaze direction of the occupant detected by the detector;
determine a target operation according to the gesture of the occupant detected by the detector; and
execute the target operation with respect to the display gazed at by the occupant, according to the display gazed at by the determined occupant and the determined target operation.

2. The vehicle multi-screen control system of claim 1, wherein the controller is further configured to:
determine whether the occupant detected by the detector has a control authority with respect to the display gazed at by the occupant, after determining the display gazed at by the occupant and the target operation; and
execute the target operation with respect to the display gazed at by the occupant, according to the display gazed at by the occupant and the target operation, based on that the controller concludes that the occupant detected by the detector has the control authority with respect to the display gazed at by the occupant.

3. The vehicle multi-screen control system of claim 2, wherein the controller is further configured to:
determine whether a driver detected by the detector has a control authority with respect to the display gazed at by the driver, after determining the display gazed at by the driver and the target operation, based on that the occupant detected by the detector is the driver, and determine whether a current vehicle speed is smaller than a predetermined value; and
execute the target operation with respect to the display gazed at by the driver, according to the display gazed at by the driver and the target operation, based on that the controller concludes that the driver has the control authority with respect to the display gazed at by the driver and the current vehicle speed is smaller than the predetermined value.

4. The vehicle multi-screen control system of claim 2, wherein the controller is further configured to:
obtain a control authority relationship between a preset occupant and a display, in the determining of whether the occupant detected by the detector has the control authority with respect to the display gazed at by the occupant; and
determine whether the occupant detected by the detector has the control authority with respect to the display gazed at by the occupant, according to the control authority relationship between the preset occupant and the display.

5. The vehicle multi-screen control system of claim 1, wherein the target operation comprises moving a pointer displayed on the display.

6. The vehicle multi-screen control system of claim 5, wherein, based on that the controller concludes that the display gazed at by the occupant along the gaze direction of the occupant detected by the detector is changed, in the executing the target operation of moving the pointer with respect to the display gazed at by the occupant, the controller is further configured to maintain the pointer at a last location to which the pointer has moved.

7. The vehicle multi-screen control system of claim 1, wherein the detector is further configured to:
capture a facial image of the occupant, in the detecting of the gaze direction of the occupant;
determine facial feature point coordinates including eye coordinates according to the facial image, and determine a head posture according to the facial feature point coordinates; and
determine the gaze direction of the occupant according to an eye image among the eye coordinates, the head posture, and the facial image.

8. The vehicle multi-screen control system of claim 7, wherein the controller is further configured to:
obtain a screen range of each in the plurality of displays, in the determining of the display gazed at by the occupant from among the plurality of displays along the gaze direction of the occupant detected by the detector; and
determine a display from among the plurality of displays, whose screen range intersects the gaze direction of the occupant, and determine the determined display as the display gazed at by the occupant.

9. The vehicle multi-screen control system of claim 1, wherein the detector is further configured to:
capture a hand image of the occupant, while detecting the gesture of the occupant;
obtain core information of a hand from the hand image, wherein the core information comprises a finger joint or a hand edge contour; and
determine the gesture according to a state or state change of the core information of the hand.

10. The vehicle multi-screen control system of claim 9, wherein the controller is further configured to:
obtain a mapping relationship between a preset gesture and the target operation, in the determining of the target operation according to the gesture of the occupant detected by the detector; and
determine the target operation correspond to the gesture of the occupant detected by the detector, according to the mapping relationship between the preset gesture and the target operation.

11. A vehicle multi-screen control method, comprising:
detecting an occupant and a gaze direction and a gesture of the occupant;
determining, by a controller, a display gazed at by the occupant from among a plurality of displays disposed in the vehicle according to the detected gaze direction of the occupant;
determining, by the controller, a target operation according to the detected gesture of the occupant; and
executing, by the controller, the target operation with respect to the display gazed at by the occupant, according to the display gazed at by the determined occupant and the determined target operation.

12. The vehicle multi-screen control method of claim 11, further including:
determining, by the controller, whether the detected occupant has a control authority with respect to the display gazed at by the occupant, after determining the display gazed at by the occupant and the target operation; and
executing, by the controller, the target operation with respect to the display gazed at by the occupant, according to the display gazed at by the occupant and the target operation, based on that the controller concludes that the detected occupant has the control authority with respect to the display gazed at by the occupant.

13. The vehicle multi-screen control method of claim 11, further including:
determining, by the controller, whether a detected driver has a control authority with respect to the display gazed at by the driver after determining the display gazed at by the driver and the target operation, and determining, by the controller, whether a current vehicle speed is smaller than a predetermined value, based on that the detected occupant is the driver; and
executing, by the controller, the target operation with respect to the display gazed at by the driver, according to the display gazed at by the driver and the target operation, based on that the controller concludes that the driver has the control authority with respect to the display gazed at by the occupant and the current vehicle speed is smaller than the predetermined value.

14. The vehicle multi-screen control method of claim 12, wherein the determining of whether the detected occupant has the control authority with respect to the display gazed at by the occupant comprises:
obtaining, by the controller, a control authority relationship between a preset occupant and a display; and
determining, by the controller, whether the detected occupant has the control authority with respect to the display gazed at by the occupant, according to the control authority relationship between the preset occupant and the display.

15. The vehicle multi-screen control method of claim 11, wherein the target operation includes moving a pointer displayed on the display.

16. The vehicle multi-screen control method of claim 15, further including:
maintaining, by the controller, the pointer at a last location to which the pointer has moved, based on that the controller concludes that the display gazed at by the occupant along the detected gaze direction of the occupant is changed, in the executing the target operation of moving the pointer with respect to the display gazed at by the occupant.

17. The vehicle multi-screen control method of claim 11, wherein the detecting of the gaze direction of the occupant comprises:
capturing a facial image of the occupant;
determining facial feature point coordinates including eye coordinates according to the facial image, and determining a head posture according to the facial feature point coordinates; and
determining the gaze direction of the occupant according to an eye image among the eye coordinates, the head posture and the facial image.

18. The vehicle multi-screen control method of claim 17, wherein the determining of the display gazed at by the occupant from among the plurality of displays along the detected gaze direction of the occupant comprises:
obtaining, by the controller, a screen range of each in the plurality of displays; and
determining, by the controller, a display from among the plurality of displays, whose screen range intersects the gaze direction of the occupant, and determining, by the controller, the determined display as the display gazed at by the occupant.

19. The vehicle multi-screen control method of claim 11, wherein the detecting the gesture of the occupant comprises:
capturing a hand image of the occupant;
obtaining core information of a hand from the hand image, wherein the core information includes a finger joint or a hand edge contour; and
determining the gesture according to a state or state change of the core information of the hand.

20. The vehicle multi-screen control method of claim 19, wherein the determining of the target operation according to the detected gesture of the occupant comprises:
obtaining, by the controller, a mapping relationship between a preset gesture and the target operation; and
determining, by the controller, the target operation corresponding to the detected gesture of the occupant, according to the mapping relationship between the preset gesture and the target operation.
